(19) United States
(12) Patent Application Publication
(10) Pub. No.: US 2002/0103743 A1
(43) Pub. Date: Aug. 1, 2002

(54) Platform independent business to business publish/subscribe messaging system

(75) Inventor: Farrukh S. Najmi, Reading, MA (US)

Correspondence Address: BEYER WEAVER & THOMAS LLP, P.O. BOX 778, BERKELEY, CA, 94704-0778, US

(73) Assignee: Sun Microsystems, Inc.

(21) Appl. No.: 09/774,451

(22) Filed: Jan. 30, 2001

(51) Int. Cl. G06F 17/60

(52) U.S. Cl. 705/37

(57) ABSTRACT

A method, system and apparatus for dynamically multicasting a message from a first e-business entity to selected ones of a plurality of e-business entities included in a distributed computing environment is described. The system includes a registry service coupled to the plurality of e-business entities each of which subscribes to a chosen service interface included in the registry service. In the described embodiment, the subscribing is accomplished by providing information specific to each of those of the plurality of e-business entities that are subscribing to the service interface. Coupled to, or included in, the registry service is a broker that is configured to allow parties to publish and/or subscribe to specific service interfaces in the registry service. In the described embodiment, the registry service includes a list of subscribing e-business entities and associated subscribing e-business information such that when the message is published to the broker by the first e-business entity, the broker looks up the subscriber(s) to the specified service interface(s) within the registry service and then publishes the message to a service interface implemented within each of the subscribing systems.

### BACKGROUND OF THE INVENTION

1. Field of Invention

The invention relates generally to computer systems. More particularly, methods and apparatus for a business registry service that provides an independently brokered business to business messaging service that is reliable, dynamic and, when required, anonymous, in an enterprise computer system.

2. Description of Relevant Art

In modem enterprise computing environments, a number of personal computers, workstations, mainframes, and the like along with other devices such as large mass storage subsystems, network interfaces, as well as interfaces to the public telephony systems are interconnected providing an integrated environment in which information may be shared among the various users. Typically, users may be performing a variety of operations, including order receipt, manufacturing, shipping, billing, inventory control, and other operations in which sharing of data on a real time basis provides a significant advantage over, for example, maintaining separate records and attempting to reconcile them later.

With the advent of large-scale business to business (B2B) e-commerce, it has become of paramount importance for those companies (i.e., e-businesses) involved in e-commerce to be able to reliably conduct automated electronic transactions with multiple partners. Unfortunately, however, due to the lack of a unifying standard, there are no consistent rules that govern these types of B2B transactions.

However, with the advent of various e-business integration standards, such a for example, ebXML, e-businesses are beginning to conduct business process integration with their various e-business partners based upon open, interoperable communications such as XML messaging. Unfortunately, however, such communication is currently restricted to one on one communication (i.e., also referred to as point to point, or unicast) between an initiating party and a known specific partner. As e-business integration matures, however, such a restrictive form of communication will be inadequate since various partnerships will be formed dynamically based upon, for example, a just in time (JIT) model for ascertaining a most suitable partner for a particular transaction. Consider, for a moment, the example of a first party, as a buyer, sending a Request for Quote (RFQ) message to an undetermined number of anonymous sellers (in what is referred to as a multicast mode). Typically, only those sellers who have the service or product that the buyer requests would be interested in providing a Quote in response to the RFQ. In the conventional enterprise computer system, such a multicast mode would not be possible since only known and specific sellers are able to both receive and respond to the RFQ. In this scenario the buyer would have to send each sender a separate message.

Therefore, in view of the foregoing, it would be advantageous and therefore desirable to have a scalable registry service that provides a brokered business to business messaging service that is reliable, dynamic and, when required, anonymous, in an enterprise computer system.

### SUMMARY OF THE INVENTION

Broadly speaking, the invention relates to a method, apparatus and computer system for providing a scalable registry service that is reliable, dynamic and, when required, anonymous, in an enterprise computer system. The invention can be implemented in numerous ways, including as a method, a computer system, and an apparatus. Several embodiments of the invention are discussed below.

In one embodiment, a method for dynamically multicasting a message from a first e-business entity to selected ones of a plurality of e-business entities included in a distributed computer environment is described. An abstract service interface within the registry service, which describes the interface to a B2B service, is subscribed to by the plurality of e-business entities. The message is published to a message broker interface in the registry service by the first e-business entity. The broker then consults those subscriptions that are subscribed to the service interface specified as the intended target of the message. The message is then multicast by the broker to selected ones of the plurality of e-business entities.

In another embodiment, a system for dynamically multicasting a message from a first e-business entity to selected ones of a plurality of e-business entities included in a distributed computing environment is described. The system includes a registry service coupled to the plurality of e-business entities each of which subscribes to a chosen service interface included in the registry service. In the described embodiment, the subscribing is accomplished by providing information specific to each of those of the plurality of e-business entities that are subscribing to the abstract service interface within the registry. Coupled to, or included in, the registry service is a broker that is configured to allow parties to publish and/or subscribe to specific service interfaces in the registry service. In the described embodiment, the registry service includes a list of subscribing e-business entities and associated subscribing e-business information such that when the message is published to the broker by the first e-business entity, the broker looks up the subscriber(s) to the specified service interface(s) within the registry service and then publishes the message to a concrete implementation of the service interface that is implemented within each of the subscribing systems.

### BRIEF DESCRIPTION OF THE DRAWINGS

The invention, together with further advantages thereof, may best be understood by reference to the following description taken in conjunction with the accompanying drawings in which:

FIG. 1, a distributed computing system encompassing multiple business enterprises in accordance with an embodiment of the invention is shown.

FIG. 2 shows a situation where an e-buyer has published an RFQ to the registry service and a broker in accordance with an embodiment of the invention.

FIG. 3 shows a situation where an e-seller has published an anonymous response to an RFQ in accordance with an embodiment of the invention.

FIG. 4 shows a situation where an e-seller has published a response to an RFQ directly to the e-buyer in accordance with an embodiment of the invention.

FIG. 5 shows a flowchart detailing a process for communicating between a buyer and a seller each of which are in different distributed computing systems in accordance with an embodiment of the invention.

FIG. 6 illustrates a flowchart detailing a process for responding to a message in accordance with an embodiment of the invention.

FIG. 7 illustrates a computer system that can be employed to implement the present invention.

### DETAILED DESCRIPTION OF THE EMBODIMENTS

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

In general, a system arranged to provide a scalable, message broker capable registry service that is reliable, dynamic and, when required, anonymous, in an enterprise computer system is described. In a particular embodiment, in an e-business enterprise computer system, an e-buyer sends a message, such as a RFQ, to a broker included in a registry service that is coupled to a number of e-sellers each of which can be distributed amongst any number of independent enterprise computer systems. In one embodiment, certain of the e-sellers subscribe to chosen service interfaces included in the registry. By subscribing, it is meant that a particular e-seller provides information relevant to the subscribing e-seller to an associated chosen service interface. Such information can take the form of, for example, a preference filter that the broker uses to ascertain which of the subscribing e-sellers is to receive a particular message based upon, for example, specific message content. Such subscription information includes, for example, a type of service or product provided by the particular e-seller, the type of requests (such as an RFQ) to which it will respond, transport protocols, etc. In the described embodiment, a subscriber provides the relevant subscription information in form of an XML document.

Based upon the relevant subscription information, the broker forwards the RFQ to an e-seller service interface implemented by that e-seller(s) that the broker has determined is to receive the message. In some cases, the responding e-seller publishes a response (which in this example takes the form of a Quote) to an abstract service interface within the registry using the registries broker interface. The broker then forwards the response back to the e-buyer thereby maintaining the anonymity of the seller, if so desired. In other cases, however, the responding e-seller can respond directly to the requesting e-buyer thereby bypassing the broker. In this way, the invention provides the e-buyer with the ability to dynamically multicast (i.e., broadcast) a message (such as the RFQ) to any number of recipients (such as a group of e-sellers) across any requisite number of enterprise computer systems. By dynamically, it is meant that the buyer is not required to know any particular protocols for any of the enterprise computer systems to which an RFQ is ultimately sent. It should also be noted that the message and subsequent response can be anonymous in that the identity of either sending or receiving party can be concealed until such time as it is necessary to identify oneself.

Although, the invention will initially be described in terms of an e-business registry as part of an ebXML based enterprise computer system, the present invention can be used in any networked computer system.

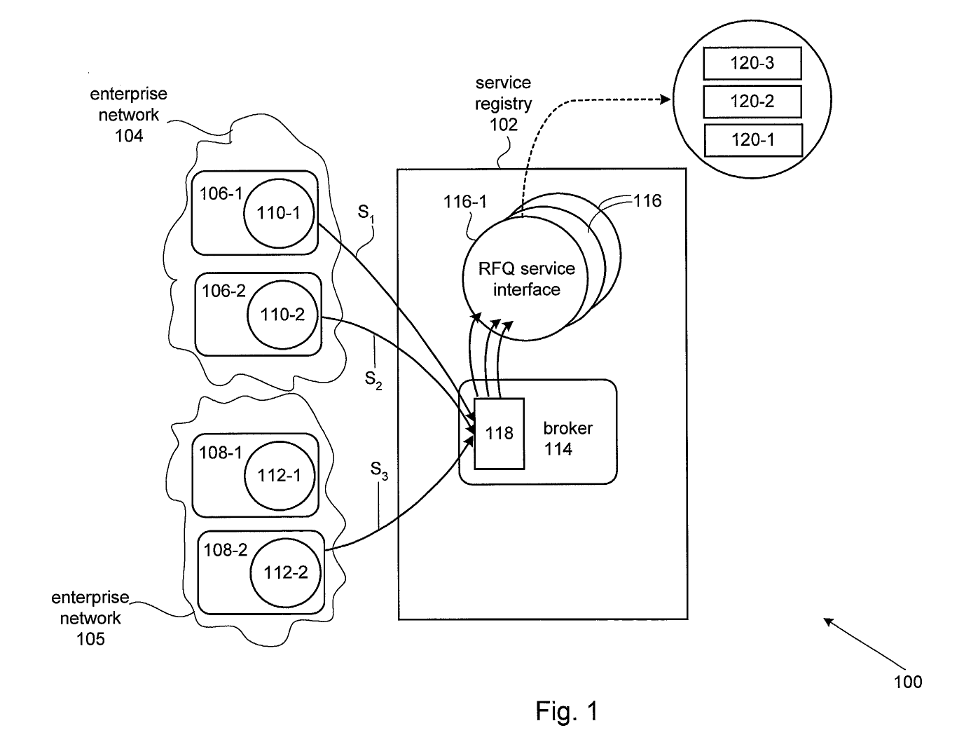

With reference to FIG. 1, a distributed computer system 100 in accordance with an embodiment of the invention is shown. It should be noted that for the sake of clarity in the following discussion, the system 100 is assumed to be an ebXML based B2B enterprise computer system. Accordingly, the system 100 includes a registry service 102 coupled to a number of enterprise computer systems 104 and 105 each having a number of e-sellers 106-1 through 106-2 and 108-1 through 108-2 by way of associated e-seller service interfaces 110-1, 110-2 and 112-1, 112-2, respectively. In the described embodiment, the registry service 102 includes a broker 114 that has access to a number of service interfaces 116 by way of a query manager interface 118 on the registry. The query manager interface 118 allows the broker 114 to query for specified service interfaces as well as subscriptions to those interfaces that are maintained within the registry.

In the described embodiment, if a particular e-seller wishes to be listed in (or otherwise identified with) any of the service interfaces 116, it must first subscribe to those service interfaces with which it desires to be associated by providing certain information. Such information can include, for example, a type of service or product provided by the particular e-seller, the type of requests (such as an RFQ) to which it will respond, transport protocols, etc.

For example, if e-seller 106-1 desires to subscribe to the registry service 102 with regards to receiving RFQs, the e-seller 106-1 provides an information set (S₁) to the registry service 102 relevant to RFQs. The registry service 102 then instantiates an RFQ service interface 116-1 which, in turn, instantiates a preference filter 120-1 associated with the e-seller 106-1. Preference filters 120-2 and 120-3 are also instantiated for e-sellers 106-2 and 112-2 based upon information sets S₂ and S₃, respectively. Such subscription information includes types of messages (such as an FQ) for which the e-seller 106-1 will respond, the transport protocol for such responses, etc.

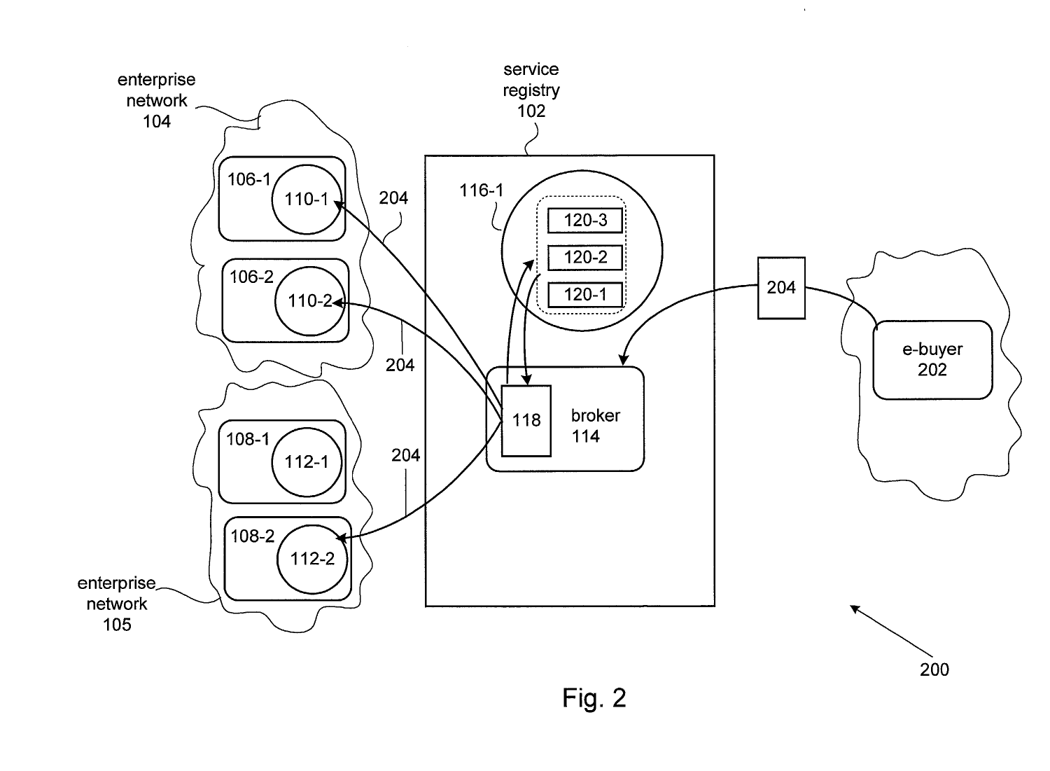

Once all of the e-sellers who wish to subscribe to the registry service 102 have done so, then a sending party, such as an e-buyer, can request bids for products and/or services by generating an RFQ, for example. The RFQ can then be broadcast to any number of e-sellers identified as being ready, willing, and able to provide such requested services and/or products. Such a situation is illustrated in FIG. 2 shows a system 200 where an e-buyer 202 has published an RFQ 204 to the broker 114 of the registry service 102 with the intent of soliciting bids (in the form of quotes) from any number of currently subscribing e-sellers. Based upon the content of the RFQ 204, the broker 114 determines which of the service interfaces is an RFQ service interface. Once the broker 114 has identified the RFQ service interface 116-1, the broker 114 looks up those e-sellers that currently are subscribing to the RFQ service interface 116-1, which in this example, are e-sellers 106-1, 106-2, and 108-2. Once the identities of the subscribing e-sellers have been determined, the broker 114 applies those preference filters corresponding to the identified subscribers, which in this example are preference filters 120-1, 120-2, and 120-3 which correspond to e-sellers 106-1, 106-2, and 108-2, respectively. In the described embodiment, the broker 114 then makes an appropriate number of copies of the RFQ 204 based upon the information provided in the various preference filters 120-1, 120-2, and 120-3. A copy of the RFQ 204 is then forwarded by the broker 114 to those e-seller service interfaces (110-1, 110-2, and 112-2) associated with those e-sellers (106-1, 106-2, and 108-2) that are to receive the RFQ 204.

It should be noted that the e-buyer 202 may not know, nor care to know, exactly who the eventual recipients of the RFQ 204 are. The only concern that the e-buyer 202 has is that the RFQ 204 is sent to the appropriate e-sellers and that a response in the form of a quote is received in a timely manner. In some cases, the e-buyer 202 can request that the RFQ 204 be anonymous until such time as a contract is formed with a particular seller or sellers. In other cases, however, the e-buyer 202 can be identified to all those e-sellers receiving the RFQ 204 while the identities of the responding e-sellers can be known or unknown.

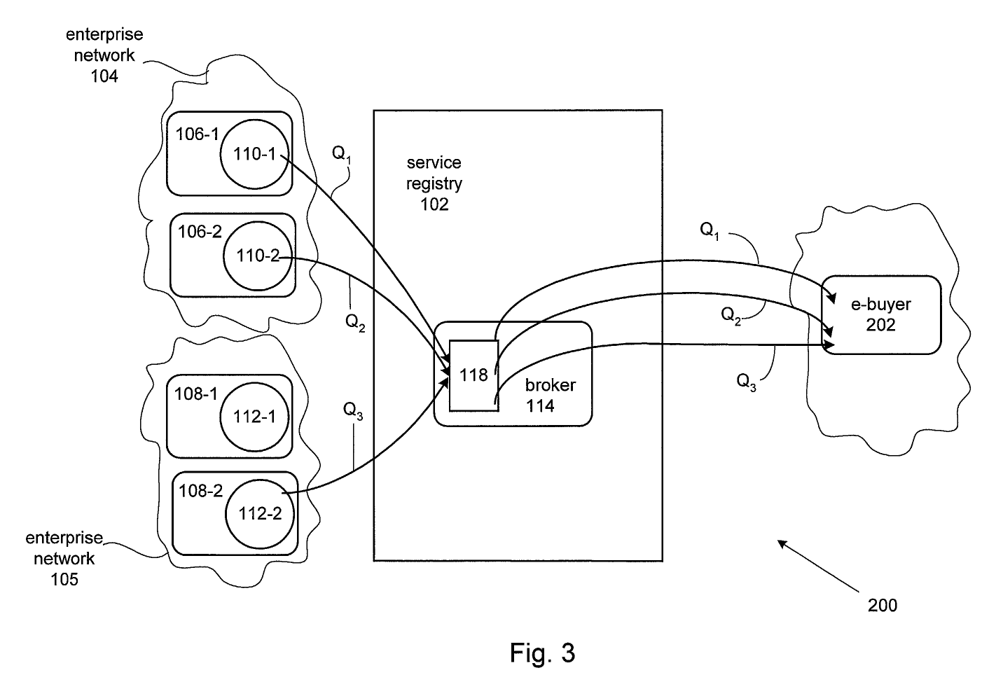

In the situation shown in FIG. 3, the identity of the responding e-sellers 106-1, 106-2, and 108-2 remains anonymous until such time as the e-buyer 202 accepts the terms of the quote and an e-contract is formed. In those cases where anonymity is desired, the responding e-sellers 106-1, 106-2, and 108-2 each sends a response Q₁, Q₂, and Q₃, respectively, back to the broker 114 which forwards each response back to the e-buyer 202 (whose identity can be ascertained, or not, based upon the RFQ 204).

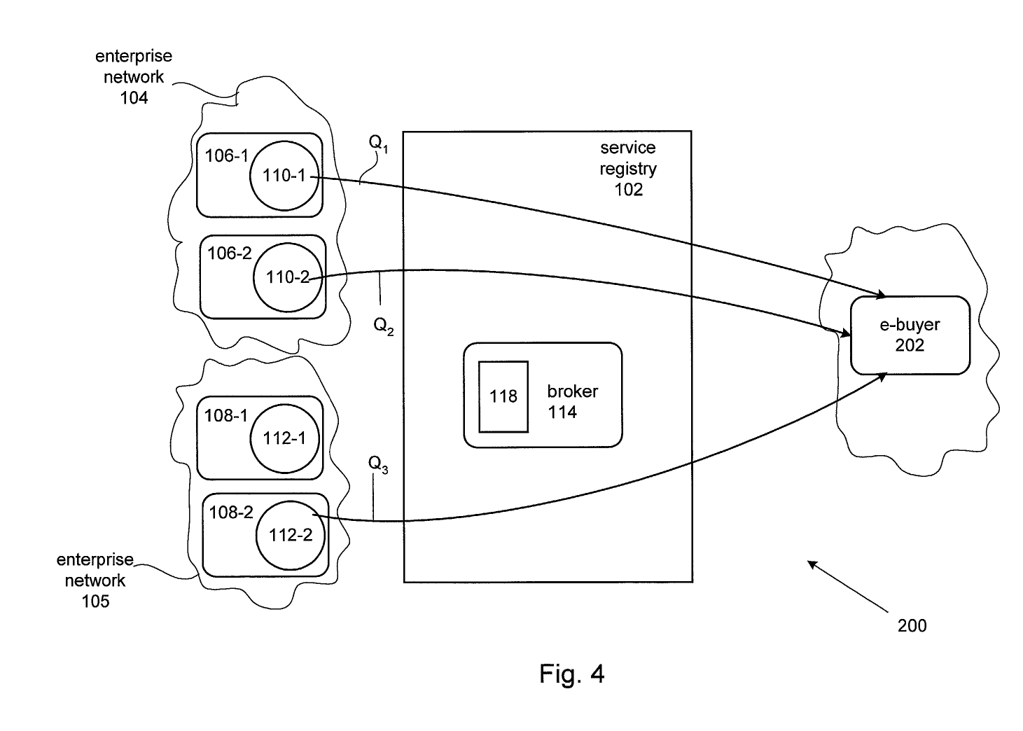

It should be noted, however, that in some cases, an e-seller can respond directly back to the e-buyer. Such a situation is shown in FIG. 4, where the identities of the responding e-sellers 106-1, 106-2, and 108-2 are revealed to the e-buyer 202 since the quotes Q₁, Q₂, and Q₃ are each sent directly to the e-buyer 202.

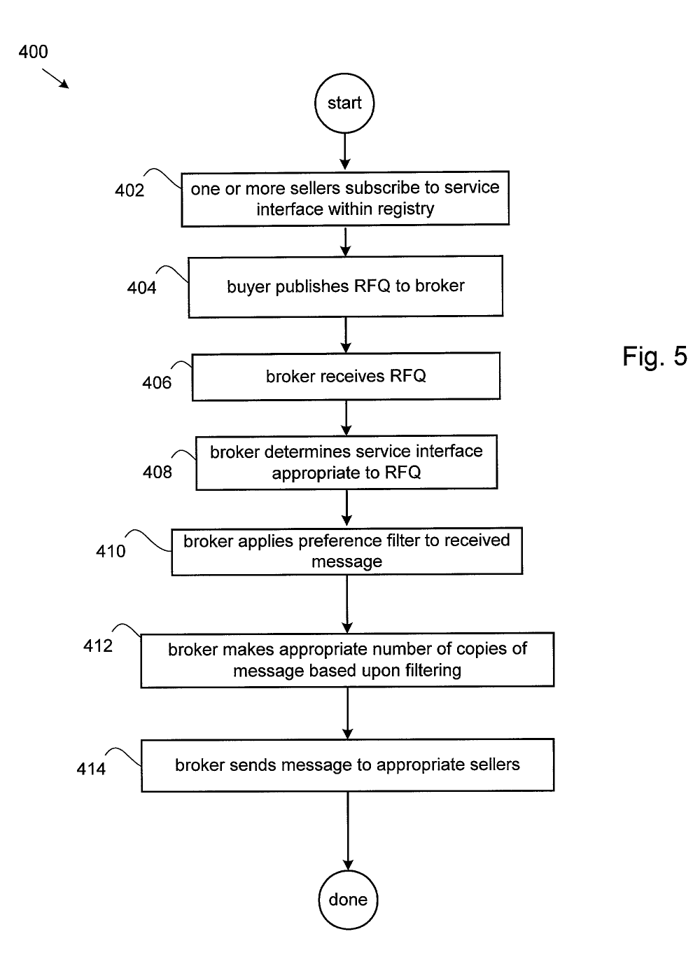

FIG. 5 illustrates a flowchart detailing a process 400 for platform independent multicast communication between a buyer and a plurality of sellers in accordance with an embodiment of the invention. The process 400 begins at 402 by a seller, or sellers, subscribing to a particular service interface included in a service registry. In one embodiment, the subscribing e-seller uses a broker interface included in the service registry. It should be noted that in some cases the buyer may publish prior to any sellers subscribing. In these cases, the broker retains the message until it expires based on an expiration date such that any sellers that subscribe after the message was sent and before the message expired will get the message. A buyer publishes a message, such as for example, an RFQ, to the broker at 404 which is received at 406. Once received by the broker, the broker looks up the appropriate service interface in the service registry as well as the subscribing e-sellers associated therewith at 408. At 410, the broker applies a preference filter based upon subscriber preferences to the received message. At 412, the broker makes an appropriate number of copies of the RFQ based upon the filtering. At 414, the broker then forwards the RFQ to an e-seller service interface corresponding to those e-sellers whose preference filter matches the message content.

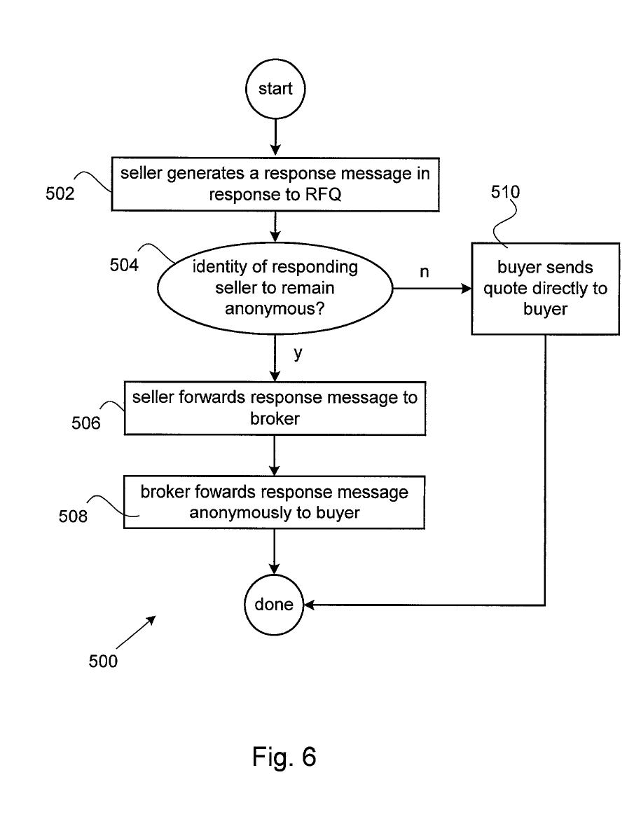

FIG. 6 illustrates a flowchart detailing a process 500 for responding to a message in accordance with an embodiment of the invention. Based upon the process 500, the e-seller responds to the received message in the form of the RFQ by generating a quote at 502. At 504, if it was determined that the identity of the responding e-seller is to remain anonymous, the quote is forwarded to the e-buyer by way of the broker at 506 which then anonymously forwards the message to the e-buyer at 508 otherwise the e-seller responds directly to e-buyer at 510.

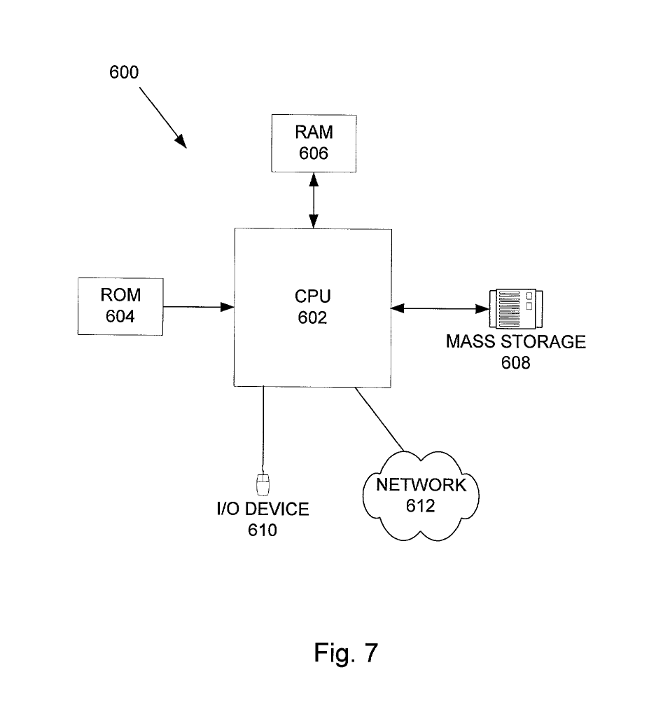

FIG. 7 illustrates a computer system 600 that can be employed to implement the present invention. The computer system 600 or, more specifically, CPUs 602, may be arranged to support a virtual machine, as will be appreciated by those skilled in the art. As is well known in the art, ROM acts to transfer data and instructions uni-directionally to the CPUs 602, while RAM is used typically to transfer data and instructions in a bi-directional manner. CPUs 602 may generally include any number of processors. Both primary storage devices 604, 606 may include any suitable computer-readable media. A secondary storage medium 608, which is typically a mass memory device, is also coupled bi-directionally to CPUs 602 and provides additional data storage capacity. The mass memory device 608 is a computer-readable medium that may be used to store programs including computer code, data, and the like. Typically, mass memory device 608 is a storage medium such as a hard disk or a tape which generally slower than primary storage devices 604, 606. Mass memory storage device 608 may take the form of a magnetic or paper tape reader or some other well-known device. It will be appreciated that the information retained within the mass memory device 608, may, in appropriate cases, be incorporated in standard fashion as part of RAM 606 as virtual memory. A specific primary storage device 604 such as a CD-ROM may also pass data uni-directionally to the CPUs 602.

CPUs 602 are also coupled to one or more input/output devices 610 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPUs 602 optionally may be coupled to a computer or telecommunications network, e.g., an Internet network, or an intranet network, using a network connection as shown generally at 612. With such a network connection, it is contemplated that the CPUs 602 might receive information from the network, or might output information to the network in the course of performing the above-described method steps. Such information, which is often represented as a sequence of instructions to be executed using CPUs 602, may be received from and outputted to the network, for example, in the form of a computer data signal embodied in a carrier wave. The above-described devices and materials will be familiar to those of skill in the computer hardware and software arts.

It should be noted that the present invention employs various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

The present invention also relates to a device, system or apparatus for performing the aforementioned operations. The system may be specially constructed for the required purposes, or it may be a general-purpose computer selectively activated or configured by a computer program stored in the computer. The processes presented above are not inherently related to any particular computer or other computing apparatus. In particular, various general-purpose computers may be used with programs written in accordance with the teachings herein, or, alternatively, it may be more convenient to construct a more specialized computer system to perform the required operations.

Although only a few embodiments of the present invention have been described, it should be understood that the present invention may be embodied in many other specific forms without departing from the spirit or the scope of the present invention.

Although the methods of providing reliable B2B communications in accordance with the present invention are particularly suitable for implementation with respect to an ebXML based environment; the methods may generally be applied in any suitable object-based environment. In particular, the methods are suitable for use in platform-independent object-based environments. It should be appreciated that the methods may also be implemented in some distributed object-oriented systems.

It should also be appreciated that the present invention may generally be implemented on any suitable object-oriented computer system. Therefore, the present examples are to be considered as illustrative and not restrictive, and the invention is not to be limited to the details given herein, but may be modified within the scope of the appended claims along with their full scope of equivalents.

What is claimed is:

1. In a distributed computing environment, a method for dynamically multicasting a message from a first entity to selected ones of a plurality of entities, comprising:
subscribing to a service interface by the certain of the plurality of entities;
publishing the message to the broker by the first entity;
determining the selected ones of the plurality of entities to receive the message by the broker; and
publishing the message to the selected ones of the plurality of entities based upon the determining by the broker.

2. A method as recited in claim 1, further comprising:
setting an expiration time for the published message;
if it is determined that none of the plurality of entities is to receive the message; then until the expiration time lapses,
retaining the published message in the broker;
determining if an appropriate one of the plurality of entities has subsequently subscribed to the service interface so as to be identified to receive the message; and
purging the message when the expiration period lapses

3. A method as recited in claim 1, further comprising:
receiving the message at each of the selected ones of the plurality of e-business entities;
reviewing the message at each of the selected ones of the plurality of e-business entities; and
determining if a response to the message is to be generated at each of the selected ones of the plurality of e-business entities based upon the reviewing.

4. A method as recited in claim 3, further comprising;
publishing the response to the service interface based upon the determining;
publishing the response to the broker by the service interface; and
publishing the response to the first e-business entity by the broker.

5. A method as recited in claim 4, wherein the responding ones of the plurality of e-business entities are each anonymous to the first e-business entity.

6. A method as recited in claim 3, further comprising:
publishing the response directly to the first e-business entity based upon the determining.

7. A method as recited in claim 6, wherein the responding ones of the plurality of e-business entities are each known to the first e-business entity.

8. A method as recited in claim 3, further comprising;
publishing the response to the service interface based upon the determining; and
publishing the response to the first e-business entity by the service interface.

9. A method as recited in claim 8, wherein the responding ones of the plurality of e-business entities are each known to the first e-business entity.

10. A method as recited in claim 1, wherein the message is a request for a quote (RFQ).

11. A method as recited in claim 1, wherein the response is a quote.

12. A method as recited in claim 1, wherein the first e-business entity is included in a first enterprise computer system and wherein at least one of the responding e-business entities is included in a second enterprise computing system.

13. A method as recited in claim 12, wherein the first and the second enterprise computing systems are different enterprise computing systems.

14. A method as recited in claim 12, wherein the first enterprise computing systems is an ebXML based enterprise computing system.

15 A method as recited in claim 12, wherein the second enterprise computing systems is an ebXML based enterprise computing system.

16. In a distributed computing environment, a system for dynamically multicasting a message from a first e-business entity to selected ones of a plurality of e-business entities, comprising:
a brokering service interface coupled to the plurality of e-business entities each of which subscribes to the service interface by providing information specific to each of the plurality of e-business entities subscribing to the service interface wherein the service interface information is associated with a list of subscribing e-business entities and associated subscribing e-business information; and
a broker with access to a service interface wherein the message is published to the broker by the first e-business entity which in turn looks up service interface description as well as subscriptions associated with said service interface, and wherein the service interface multicasts the message to the selected ones of the plurality of e-business entities based upon the information specific to each of the plurality of e-business entities subscribing to the service interface.

17. A system as recited in claim 16, wherein when the message is received at each of the selected ones of the plurality of e-business entities the message is reviewed the message at each of the selected ones of the plurality of e-business entities and, based upon the review, a determination is made whether or not a response to the message is to be generated at each of the selected ones of the plurality of e-business entities.

18. A system as recited in claim 17, wherein, based upon the determining, the response is published to the service interface, wherein the service interface publishes the response to the broker, and wherein the broker publishes the response to the first e-business entity.

19. A system as recited in claim 16, wherein the message is a request for a quote (RFQ).

20. A system as recited in claim 16, wherein the response is a quote.

21. A system as recited in claim 16 wherein the message is retained in the broker until a message expiration period lapses
